(19) United States
(12) Patent Application Publication
(10) Pub. No.: US 2023/0216568 A1
(43) Pub. Date: Jul. 6, 2023

(54) METHODS, APPARATUS AND SYSTEMS FOR CHANNEL QUALITY INFORMATION FEEDBACK

(71) Applicant: ZTE CORPORATION, Shenzhen (CN)

(72) Inventors: Chenchen ZHANG, Shenzhen (CN); Peng Hao, Shenzhen (CN); Wei Gou, Shenzhen (CN)

(73) Assignee: ZTE CORPORATION, Shenzhen (CN)

(21) Appl. No.: 18/116,572

(22) Filed: Mar. 2, 2023

Related U.S. Application Data
(63) Continuation of application No. PCT/CN2020/121043, filed on Oct. 15, 2020.

(51) Int. Cl. H04B 7/06; H04L 1/1829; H04W 72/20

(52) U.S. Cl. CPC H04B 7/0626; H04L 1/1861; H04B 7/0639; H04W 72/20; H04L 1/1812

(57) ABSTRACT

Methods, apparatus and systems for channel quality feedback in a wireless communication are disclosed. In one embodiment, a method performed by a wireless communication device is disclosed. The method comprises: performing a measurement based on at least one of: a channel state information reference signal (CSI-RS) resource, a channel state information interference measurement (CSI-IM) resource, or a transport block transmitted in a downlink transmission channel from a wireless communication node; generating at least one feedback related to channel state information (CSI) based on the measurement; and transmitting the at least one feedback to the wireless communication node.

### TECHNICAL FIELD

The disclosure relates generally to wireless communications and, more particularly, to methods, apparatus and systems for channel quality feedback in a wireless communication.

### BACKGROUND

A fifth-generation (5G) new radio (NR) network will support Ultra-Reliable and Low Latency Communications (URLLC) applications such as smart vehicle control, drone control, robotic surgery and MTC applications like industry automation, etc. that require new solutions to address the demands for lower latency. Considering the low delay and high reliability of the URLLC service, a terminal, or a user equipment (UE), needs to feed back more accurate and more timely channel state information to the base station, such that the base station can perform more reasonable link self-adaptation to ensure the URLLC service requirements. In a URLLC service scenario with strict requirements for latency, it is not allowed to improve the reliability of service channel by receiving multiple times of re-transmissions. In this case, the terminal should provide feedback of channel state information to the base station in a timely and accurate manner.

In addition, in the URLLC scenario, the link self-adaptation effect may be poor because the interference jitter is too severe. If the interference jitter can be reflected in the channel state information fed back by the terminal, the base station can perform better link self-adaptation according to the feedback from the terminal. But there is no existing solution either to make UEs measure channel state information that reflects interference jitter, or to make UEs send more timely and accurate channel state information to base station.

### SUMMARY OF THE INVENTION

The exemplary embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

In one embodiment, a method performed by a wireless communication device is disclosed. The method comprises: performing a measurement based on at least one of: a channel state information reference signal (CSI-RS) resource, a channel state information interference measurement (CSI-IM) resource, or a transport block transmitted in a downlink transmission channel from a wireless communication node; generating at least one feedback related to channel state information (CSI) based on the measurement; and transmitting the at least one feedback to the wireless communication node.

In a further embodiment, a method performed by a wireless communication device is disclosed. The method comprises: determining whether a DCI triggering sounding reference signal (SRS) resource is a unicast scheduling DCI or a multicast or broadcast scheduling DCI; when the DCI is a unicast scheduling DCI, selecting a first SRS resource group from SRS resource groups for antenna switching based on unicast, based on an indication of a SRS triggering field in the DCI; when the DCI is a multicast or broadcast scheduling DCI, selecting a second SRS resource group from SRS resource groups for antenna switching based on multicast or broadcast, based on an indication of a SRS triggering field in the DCI; and transmitting the SRS resource to the wireless communication node according to the selected SRS resource group.

In another embodiment, a method performed by a wireless communication node is disclosed. The method comprises: performing a downlink transmission on a downlink transmission channel to a wireless communication device; and receiving, from the wireless communication device, at least one feedback related to channel state information (CSI). The at least one feedback is generated based on at least one of: a channel state information reference signal (CSI-RS) resource, a channel state information interference measurement (CSI-IM) resource, or a transport block transmitted in the downlink transmission channel.

In yet another embodiment, a method performed by a wireless communication node is disclosed. The method comprises: receiving, from a wireless communication device, a sounding reference signal (SRS) resource generated based on a scheduling type of downlink control information (DCI) triggering the SRS resource from the wireless communication node. The DCI is determined by the wireless communication device to be a unicast scheduling DCI or a multicast or broadcast scheduling DCI. When the DCI is determined to be a unicast scheduling DCI, a first SRS resource group is selected by the wireless communication device from SRS resource groups for antenna switching based on unicast, based on an indication of a SRS triggering field in the DCI. When the DCI is determined to be a multicast or broadcast scheduling DCI, a second SRS resource group is selected by the wireless communication device from SRS resource groups for antenna switching based on multicast or broadcast, based on an indication of a SRS triggering field in the DCI. The SRS resource is received according to the selected SRS resource group.

In a different embodiment, a wireless communication node configured to carry out a disclosed method in some embodiment is disclosed. In yet another embodiment, a wireless communication device configured to carry out a disclosed method in some embodiment is disclosed. In still another embodiment, a non-transitory computer-readable medium having stored thereon computer-executable instructions for carrying out a disclosed method in some embodiment is disclosed.

### BRIEF DESCRIPTION OF THE DRAWINGS

Various exemplary embodiments of the present disclosure are described in detail below with reference to the following Figures. The drawings are provided for purposes of illustration only and merely depict exemplary embodiments of the present disclosure to facilitate the reader's understanding of the present disclosure. Therefore, the drawings should not be considered limiting of the breadth, scope, or applicability of the present disclosure. It should be noted that for clarity and ease of illustration these drawings are not necessarily drawn to scale.

FIG. 1 illustrates an exemplary communication network in which techniques disclosed herein may be implemented, in accordance with an embodiment of the present disclosure.

FIG. 2 illustrates a block diagram of a base station (BS), in accordance with some embodiments of the present disclosure.

FIG. 3A illustrates a flow chart for a method performed by a BS for channel quality feedback, in accordance with some embodiments of the present disclosure.

FIG. 3B illustrates a flow chart for another method performed by a BS for channel quality feedback, in accordance with some embodiments of the present disclosure.

FIG. 4 illustrates a block diagram of a user equipment (UE), in accordance with some embodiments of the present disclosure.

FIG. 5A illustrates a flow chart for a method performed by a UE for channel quality feedback, in accordance with some embodiments of the present disclosure.

FIG. 5B illustrates a flow chart for another method performed by a UE for channel quality feedback, in accordance with some embodiments of the present disclosure.

### DETAILED DESCRIPTION OF EXEMPLARY EMBODIMENTS

Various exemplary embodiments of the present disclosure are described below with reference to the accompanying figures to enable a person of ordinary skill in the art to make and use the present disclosure. As would be apparent to those of ordinary skill in the art, after reading the present disclosure, various changes or modifications to the examples described herein can be made without departing from the scope of the present disclosure. Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

A typical wireless communication network includes one or more base stations (typically known as a “BS”) that each provides geographical radio coverage, and one or more wireless user equipment devices (typically known as a “UE”) that can transmit and receive data within the radio coverage. In the wireless communication network, a BS and a UE can communicate with each other via a communication link, e.g., via a downlink (DL) radio frame from the BS to the UE or via an uplink (UL) radio frame from the UE to the BS.

In a current new radio (NR) standard, the feedback of aperiodic channel state information can only be triggered by the physical downlink control channel (PDCCH) carrying UL Grant, and is sent in the physical uplink shared channel (PUSCH) scheduled by the UL Grant. In this mode, if there is no UL shared channel (SCH) to be sent, the BS will have to send the PDCCH carrying UL Grant to trigger the aperiodic channel state feedback. This may cause the PDCCH to be blocked. One solution is that the PDCCH carrying the DL Grant can trigger the feedback of the aperiodic channel state information, and the DL Grant can schedule the physical downlink shared channel (PDSCH) at the same time. Thus, the triggering of aperiodic channel state information feedback is enhanced. When the BS has PUSCH to be scheduled and the terminal needs to feed back the channel state information, the UL Grant can trigger the aperiodic channel state information feedback. When the BS has PDSCH to be scheduled and the terminal needs to feed back the channel state information, the DL Grant can trigger the aperiodic channel state information feedback. After the terminal decodes the PDSCH transport block (TB) as negative acknowledgement (NACK), it can trigger the feedback of the aperiodic channel state information, such that the feedback of the aperiodic channel state information can be applied to the retransmission link self-adaptation of the PDSCH TB as soon as possible.

After decoding the PDSCH, the terminal generates a hybrid automatic repeat request acknowledgement (HARQ-ACK) feedback for this PDSCH according to the decoding result, and carries the HARQ-ACK feedback on the physical uplink control channel (PUCCH) to the BS. To carry HARQ-ACK feedback for multiple PDSCHs on one PUCCH, the semi-static HARQ-ACK codebook and dynamic HARQ-ACK codebook modes are introduced to NR. In the dynamic HARQ codebook mode, based on the K1 indication of multiple PDSCHs, the BS sends back the HARQ-ACK feedback for multiple PDSCHs to a certain PUCCH resource of a slot indicated by the K1 (a PDSCH-to-HARQ feedback timing indicator) and PRI (a PUCCH resource indicator) in the last downlink control information (DCI). The K1 indicates the offset between the slot where DCI is located and the slot where PUCCH is located; and the PRI indicates the PUCCH Resource index. In one case, the DCI dispatching the PDSCH or PUSCH has a priority indicator field to indicate the priority information. With this priority indicator field, the HARQ-ACK feedback of the decoding result of the scheduled PDSCH can be divided into high priority feedback and low priority feedback.

The present disclosure provides methods and systems for a terminal or a UE to perform a downlink channel measurement based on at least one of: a channel state information reference signal (CSI-RS) resource, a channel state information interference measurement (CSI-IM) resource, or a transport block transmitted in a downlink transmission channel from a BS. The UE can generate a feedback related to channel state information (CSI) based on the measurement, e.g. based on content of a HARQ-ACK message in response to the downlink transmission transport block. The UE can transmit the feedback to the BS in a timely and accurate manner. In one embodiment, in accordance with channel reciprocity, the BS can determine downlink CSI information based on a sounding reference signal (SRS) resource transmitted by the UE. The SRS resource is transmitted based on whether the DCI triggering the SRS resource is a unicast scheduling DCI or a multicast or broadcast scheduling DCI.

The methods disclosed in the present teaching can be implemented in a wireless communication network, where a BS and a UE can communicate with each other via a communication link, e.g., via a downlink radio frame from the BS to the UE or via an uplink radio frame from the UE to the BS. In various embodiments, a BS in the present disclosure can be referred to as a network side and can include, or be implemented as, a next Generation Node B (gNB), an E-UTRAN Node B (eNB), a Transmission/Reception Point (TRP), an Access Point (AP), an AP MLD, a non-terrestrial reception point for satellite/fire balloon/unmanned aerial vehicle (UAV) communication, a radio transceiver in a vehicle of a vehicle-to-vehicle (V2V) wireless network, etc.; while a UE in the present disclosure can be referred to as a terminal and can include, or be implemented as, a mobile station (MS), a station (STA), a non-AP MLD, a terrestrial device for satellite/fire balloon/unmanned aerial vehicle (UAV) communication, a radio transceiver in a vehicle of a vehicle-to-vehicle (V2V) wireless network, etc.

In various embodiments of the present teaching, the two ends of a communication, e.g., a BS and a UE, may be described herein as non-limiting examples of “wireless communication node,” and “wireless communication device” respectively, which can practice the methods disclosed herein and may be capable of wireless and/or wired communications, in accordance with various embodiments of the present disclosure.

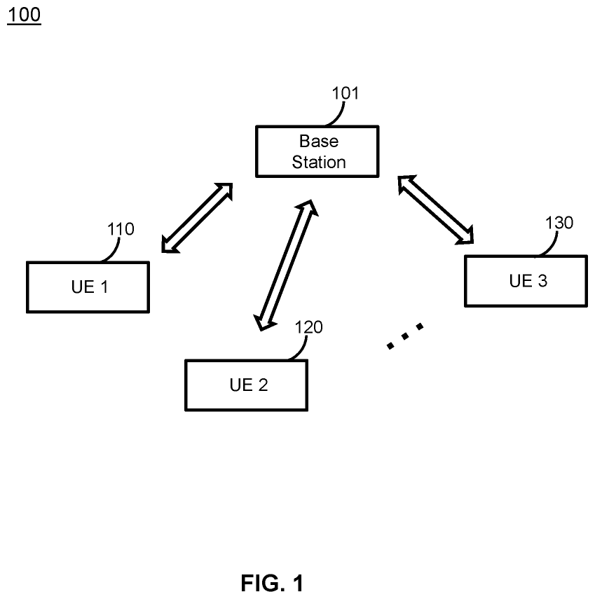

FIG. 1 illustrates an exemplary communication network 100 in which techniques disclosed herein may be implemented, in accordance with an embodiment of the present disclosure. As shown in FIG. 1, the exemplary communication network 100 includes a base station (BS) 101 and a plurality of UEs, UE 1 110, UE 2 120 . . . UE 3 130, where the BS 101 can communicate with the UEs according to wireless protocols. To ensure transmission reliability, the BS 101 needs to perform link adaptation based on channel quality feedback from the UEs. In an application of URLLC service, it is desirable to have this channel quality feedback (e.g. CSI feedback) sent by each UE in a timely and accurate manner.

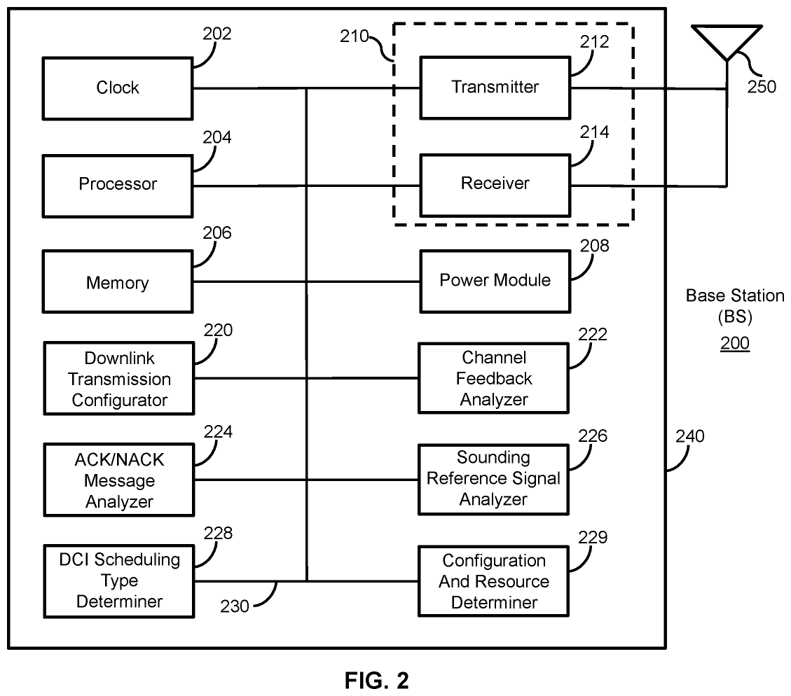

FIG. 2 illustrates a block diagram of a base station (BS) 200, in accordance with some embodiments of the present disclosure. The BS 200 is an example of a node or device that can be configured to implement the various methods described herein. As shown in FIG. 2, the BS 200 includes a housing 240 containing a system clock 202, a processor 204, a memory 206, a transceiver 210 comprising a transmitter 212 and receiver 214, a power module 208, a downlink transmission configurator 220, a channel feedback analyzer 222, an ACK/NACK message analyzer 224, a sounding reference signal analyzer 226, a DCI scheduling type determiner 228 and a configuration and resource determiner 229.

In this embodiment, the system clock 202 provides the timing signals to the processor 204 for controlling the timing of all operations of the BS 200. The processor 204 controls the general operation of the BS 200 and can include one or more processing circuits or modules such as a central processing unit (CPU) and/or any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable circuits, devices and/or structures that can perform calculations or other manipulations of data.

The memory 206, which can include both read-only memory (ROM) and random access memory (RAM), can provide instructions and data to the processor 204. A portion of the memory 206 can also include non-volatile random access memory (NVRAM). The processor 204 typically performs logical and arithmetic operations based on program instructions stored within the memory 206. The instructions (a.k.a., software) stored in the memory 206 can be executed by the processor 204 to perform the methods described herein. The processor 204 and memory 206 together form a processing system that stores and executes software. As used herein, “software” means any type of instructions, whether referred to as software, firmware, middleware, microcode, etc., which can configure a machine or device to perform one or more desired functions or processes. Instructions can include code (e.g., in source code format, binary code format, executable code format, or any other suitable format of code). The instructions, when executed by the one or more processors, cause the processing system to perform the various functions described herein.

The transceiver 210, which includes the transmitter 212 and receiver 214, allows the BS 200 to transmit and receive data to and from a remote device (e.g., a UE or another BS). An antenna 250 is typically attached to the housing 240 and electrically coupled to the transceiver 210. In various embodiments, the BS 200 includes (not shown) multiple transmitters, multiple receivers, and multiple transceivers. In one embodiment, the antenna 250 is replaced with a multi-antenna array 250 that can form a plurality of beams each of which points in a distinct direction. The transmitter 212 can be configured to wirelessly transmit packets having different packet types or functions, such packets being generated by the processor 204. Similarly, the receiver 214 is configured to receive packets having different packet types or functions, and the processor 204 is configured to process packets of a plurality of different packet types. For example, the processor 204 can be configured to determine the type of packet and to process the packet and/or fields of the packet accordingly.

In a wireless communication, the downlink transmission configurator 220 in the BS 200 can configure and perform a downlink transmission on a downlink transmission channel to a UE. In various embodiments, the channel feedback analyzer 222 can receive, from the UE via the receiver 214, and analyze at least one feedback related to channel state information (CSI). The at least one feedback is generated based on at least one of: a channel state information reference signal (CSI-RS) resource, a channel state information interference measurement (CSI-IM) resource, or a transport block transmitted in a downlink transmission channel.

In one embodiment, the ACK/NACK message analyzer 224 in this example can analyze a hybrid automatic repeat request acknowledgement (HARQ-ACK) message in the at least one feedback that is generated based on the HARQ-ACK message in response to the downlink transmission. In one embodiment, the at least one feedback has a type that is selected from a plurality of types based on content of the HARQ-ACK message. The at least one feedback has a first type when the HARQ-ACK message has a first content; and the at least one feedback has a second type when the HARQ-ACK message has a second content. In one embodiment, the first content is acknowledgement (ACK); and the second content is negative acknowledgement (NACK).

In one embodiment, the first type corresponds to at least one of the following feedbacks: a degree to which a decoding of the downlink transmission is correct; a recommended modulation coding scheme (MCS); a differential MCS between a recommended MCS and a scheduled MCS; a recommended channel quality indicator (CQI); a differential CQI between a recommended CQI and a scheduled CQI; a recommended pre-coding matrix indicator (PMI); a differential PMI between a recommended PMI and a scheduled PMI; a recommended rank indicator (RI); a recommended beam index; a recommended transmission configuration indication (TCI) state; a recommended CSI-RS resource indicator; a recommended synchronization signal block (SSB) index; a recommended frequency domain index that is used or not used by the BS 200; or an indication indicating whether to trigger a new CSI feedback by the BS 200. In one embodiment, the second type corresponds to at least one of the following feedbacks: a degree to which a decoding of the downlink transmission is incorrect; a recommended modulation coding scheme (MCS); a differential MCS between a recommended MCS and a scheduled MCS; a recommended channel quality indicator (CQI); a differential CQI between a recommended CQI and a scheduled CQI; a recommended pre-coding matrix indicator (PMI); a differential PMI between a recommended PMI and a scheduled PMI; a recommended rank indicator (RI); a recommended beam index; a recommended transmission configuration indication (TCI) state; a recommended CSI-RS resource indicator; a recommended synchronization signal block (SSB) index; or a recommended frequency domain index that is used or not used by the BS 200.

In one embodiment, when the HARQ-ACK message corresponds to one transport block transmitted in physical downlink shared channel (PDSCH), the at least one feedback is one feedback generated based on the transport block transmitted in the PDSCH corresponding to the HARQ-ACK message. In another embodiment, when the HARQ-ACK message corresponds to a plurality of transport blocks transmitted in one or multiple PDSCHs associated with a HARQ-ACK codebook, the at least one feedback comprises one of: one feedback generated based on an ACK or NACK, in the HARQ-ACK message, corresponding to a last transport block transmitted in PDSCH corresponding to the HARQ-ACK codebook; one feedback generated based on an ACK or NACK, in the HARQ-ACK message, corresponding to a transport block transmitted in PDSCH last among the plurality of transport blocks (transmitted on the PDSCH) corresponding to the HARQ-ACK codebook before transmitting the at least one feedback; one feedback generated based on a last NACK corresponding to the HARQ-ACK codebook, in the HARQ-ACK message, when the HARQ-ACK message comprises NACK; one feedback generated based on a NACK, in the HARQ-ACK message, corresponding to a transport block transmitted in PDSCH last among the plurality of transport blocks corresponding to the HARQ-ACK codebook before transmitting the at least one feedback, when the HARQ-ACK message comprises NACK; one feedback generated based on a last ACK corresponding to the HARQ-ACK codebook, in the HARQ-ACK message, when the HARQ-ACK message comprises no NACK; one feedback generated based on an ACK, in the HARQ-ACK message, corresponding to a transport block transmitted in PDSCH last among the plurality of transport blocks corresponding to the HARQ-ACK codebook before transmitting the at least one feedback, when the HARQ-ACK message comprises no NACK; one feedback generated based on a transport block transmitted in PDSCH having a worst CSI among the plurality of transport blocks, when the HARQ-ACK message comprises no NACK; one feedback generated based on a transport block transmitted in PDSCH having a worst CSI among the plurality of transport blocks corresponding to all NACKs in the HARQ-ACK message, when the HARQ-ACK message comprises multiple NACKs; one feedback generated based on an average CSI of transport blocks transmitted in PDSCHs corresponding to all NACKs in the HARQ-ACK message, when the HARQ-ACK message comprises multiple NACKs; or a plurality of feedbacks each of which corresponds to a respective transport block transmitted in PDSCH among the plurality of PDSCHs and is generated based on an ACK or NACK, in the HARQ-ACK message, corresponding to the respective PDSCH.

In one embodiment, the at least one feedback is generated based on: selecting at least one CSI-RS occasion; performing a channel measurement filtering based on the at least one CSI-RS occasion; calculating a channel quality value based on the channel measurement filtering; and generating the at least one feedback based on the channel quality value. The at least one CSI-RS occasion is selected based on at least one of the following: all CSI-RS occasions no later than a reference resource of the at least one feedback (e.g. a CSI reference resource associated with a CSI resource setting, and the CSI resource setting is related to the at least one feedback); CSI-RS occasions with channel peak values, among all CSI-RS occasions no later than the reference resource of the at least one feedback, wherein each channel peak value is a maximum value or a value larger than a threshold determined based on a semi-static configuration by the BS 200 or based on a system pre-definition; CSI-RS occasions with channel peak values, among all CSI-RS occasions no later than the reference resource of the at least one feedback, wherein each channel peak value is determined based on: an average channel value calculated based on channel values measured on all CSI-RS occasions before the reference resource, and a threshold determined based on a semi-static configuration by the BS 200 or based on a system pre-definition, where a channel peak value is a channel value larger than the average channel value by a difference value larger than or equal to the threshold; CSI-RS occasions with top N channel values, among all CSI-RS occasions no later than the reference resource of the at least one feedback, wherein N is a positive integer determined based on a semi-static configuration by the BS 200 or based on a system pre-definition; CSI-RS occasions with channel valley values, among all CSI-RS occasions no later than the reference resource of the at least one feedback, wherein each channel valley value is a minimum value or a value smaller than a threshold determined based on a semi-static configuration by the BS 200 or based on a system pre-definition; CSI-RS occasions with channel valley values, among all CSI-RS occasions no later than the reference resource of the at least one feedback, wherein each channel valley value is determined based on: an average channel value calculated based on channel values measured on all CSI-RS occasions before the reference resource, and a threshold determined based on a semi-static configuration by the BS 200 or based on a system pre-definition, where a channel valley value is a channel value less than the average channel value by a difference value larger than or equal to the threshold; CSI-RS occasions with bottom M channel values, among all CSI-RS occasions no later than the reference resource of the at least one feedback, wherein M is a positive integer determined based on a semi-static configuration by the BS 200 or based on a system pre-definition; CSI-RS occasions without channel peak values, among all CSI-RS occasions no later than the reference resource of the at least one feedback, where the channel peak values can be defined in the way as discussed before; CSI-RS occasions without channel valley values, among all CSI-RS occasions no later than the reference resource of the at least one feedback, where the channel valley values can be defined in the way as discussed before; or latest L CSI-RS occasions among all CSI-RS occasions no later than the reference resource of the at least one feedback, wherein L is a positive integer determined based on a semi-static configuration by the BS 200 or based on a system pre-definition.

In another embodiment, the at least one feedback is generated based on: selecting at least one CSI-RS occasion or at least one CSI-IM occasion; performing an interference measurement filtering based on the at least one CSI-RS occasion or the at least one CSI-IM occasion; calculating an interference quality value based on the interference measurement filtering; and generating the at least one feedback based on the interference quality value. The at least one CSI-RS occasion or the at least one CSI-IM occasion is selected based on at least one of the following: all CSI-RS or CSI-IM occasions no later than a reference resource of the at least one feedback; CSI-RS or CSI-IM occasions with interference peak values, among all CSI-RS or CSI-IM occasions no later than the reference resource of the at least one feedback, wherein each interference peak value is a maximum value or a value larger than a threshold determined based on a semi-static configuration by the BS 200 or based on a system pre-definition; CSI-RS or CSI-IM occasions with interference peak values, among all CSI-RS or CSI-IM occasions no later than the reference resource of the at least one feedback, wherein each interference peak value is determined based on: an average interference value calculated based on interference values measured on all CSI-RS occasions before the reference resource, and a threshold determined based on a semi-static configuration by the BS 200 or based on a system pre-definition, where an interference peak value is an interference value larger than the average interference value by a difference value larger than or equal to the threshold; CSI-RS or CSI-IM occasions with top X interference values, among all CSI-RS or CSI-IM occasions no later than the reference resource of the at least one feedback, wherein X is a positive integer determined based on a semi-static configuration by the BS 200 or based on a system pre-definition; CSI-RS or CSI-IM occasions with interference valley values, among all CSI-RS or CSI-IM occasions no later than the reference resource of the at least one feedback, wherein each interference valley value is a minimum value or a value smaller than a threshold determined based on a semi-static configuration by the BS 200 or based on a system pre-definition; CSI-RS or CSI-IM occasions with interference valley values, among all CSI-RS or CSI-IM occasions no later than the reference resource of the at least one feedback, wherein each interference valley value is determined based on: an average interference value calculated based on interference values measured on all CSI-RS occasions before the reference resource, and a threshold determined based on a semi-static configuration by the BS 200 or based on a system pre-definition, where an interference valley value is an interference value less than the average interference value by a difference value larger than or equal to the threshold; CSI-RS or CSI-IM occasions with bottom Y interference values, among all CSI-RS or CSI-IM occasions no later than the reference resource of the at least one feedback, wherein Y is a positive integer determined based on a semi-static configuration by the BS 200 or based on a system pre-definition; CSI-RS or CSI-IM occasions without interference peak values, among all CSI-RS or CSI-IM occasions no later than the reference resource of the at least one feedback, where the interference peak values can be defined in the way as discussed before; CSI-RS or CSI-IM occasions without interference valley values, among all CSI-RS or CSI-IM occasions no later than the reference resource of the at least one feedback, where the interference valley values can be defined in the way as discussed before; or latest Z CSI-RS or CSI-IM occasions among all CSI-RS or CSI-IM occasions no later than the reference resource of the at least one feedback, wherein Z is a positive integer determined based on a semi-static configuration by the BS 200 or based on a system pre-definition.

In one embodiment, the at least one feedback is generated based on a scheduling type of downlink control information (DCI) triggering the at least one feedback. The DCI scheduling type determiner 228 in this example can determine DCI scheduling type, e.g. whether the DCI is a unicast scheduling DCI or a multicast or broadcast scheduling DCI. The UE can also determine whether the DCI is a unicast scheduling DCI or a multicast or broadcast scheduling DCI, based on at least one of: a radio network temporary identifier (RNTI) scrambling the DCI, a DCI format in which the DCI is transmitted, a DMRS type of the DCI (different DMRS types can be defined by different DMRS pattern or different DMRS sequence), or a pre-determined field of the DCI. In one embodiment, when the DCI is determined to be a unicast scheduling DCI, a first configuration is selected by the UE for the at least one feedback from CSI feedback configurations for unicast, based on an indication of a CSI feedback triggering field in the DCI; and when the DCI is determined to be a multicast or broadcast scheduling DCI, a second configuration is selected by the UE for the at least one feedback from CSI feedback configurations for multicast or broadcast, based on an indication of a CSI feedback triggering field in the DCI. The CSI feedback configurations for unicast, multicast or broadcast may be determined based on a semi-static configuration by the configuration and resource determiner 229 or based on a system pre-definition.

In another embodiment, when the DCI is determined to be a unicast scheduling DCI, a physical uplink control channel (PUCCH) resource is determined for transmitting the at least one feedback, based on a first method; and when the DCI is determined to be a multicast or broadcast scheduling DCI, a physical uplink control channel (PUCCH) resource is determined for transmitting the at least one feedback, based on a second method different from the first method. The first and second methods may be determined based on a semi-static configuration by the configuration and resource determiner 229 or based on a system pre-definition.

The sounding reference signal analyzer 226 in this example can receive, from a UE via the receiver 214, and analyze a sounding reference signal (SRS) resource generated based on a scheduling type of downlink control information (DCI) triggering the SRS. The DCI may be transmitted by the B S 200. The DCI scheduling type determiner 228 in this example can determine DCI scheduling type, e.g. whether the DCI is a unicast scheduling DCI or a multicast or broadcast scheduling DCI. The UE can also determine whether the DCI is a unicast scheduling DCI or a multicast or broadcast scheduling DCI, e.g. based on at least one of: a radio network temporary identifier (RNTI) scrambling the DCI, a DCI format in which the DCI is transmitted, a DMRS type of the DCI (different DMRS types can be defined by different DMRS pattern or different DMRS sequence), or a pre-determined field of the DCI.

In one embodiment, when the DCI is determined to be a unicast scheduling DCI, a first SRS resource group is selected by the UE from SRS resource groups for antenna switching based on unicast, based on an indication of a SRS triggering field in the DCI; when the DCI is determined to be a multicast or broadcast scheduling DCI, a second SRS resource group is selected by the UE from SRS resource groups for antenna switching based on multicast or broadcast, based on an indication of a SRS triggering field in the DCI. The SRS resource is received according to the selected SRS resource group. The SRS resource groups for antenna switching based on unicast, multicast or broadcast are determined based on a semi-static configuration by the configuration and resource determiner 229 or based on a system pre-definition.

The power module 208 can include a power source such as one or more batteries, and a power regulator, to provide regulated power to each of the above-described modules in FIG. 2. In some embodiments, if the BS 200 is coupled to a dedicated external power source (e.g., a wall electrical outlet), the power module 208 can include a transformer and a power regulator.

The various modules discussed above are coupled together by a bus system 230. The bus system 230 can include a data bus and, for example, a power bus, a control signal bus, and/or a status signal bus in addition to the data bus. It is understood that the modules of the BS 200 can be operatively coupled to one another using any suitable techniques and mediums.

Although a number of separate modules or components are illustrated in FIG. 2, persons of ordinary skill in the art will understand that one or more of the modules can be combined or commonly implemented. For example, the processor 204 can implement not only the functionality described above with respect to the processor 204, but also implement the functionality described above with respect to the downlink transmission configurator 220. Conversely, each of the modules illustrated in FIG. 2 can be implemented using a plurality of separate components or elements.

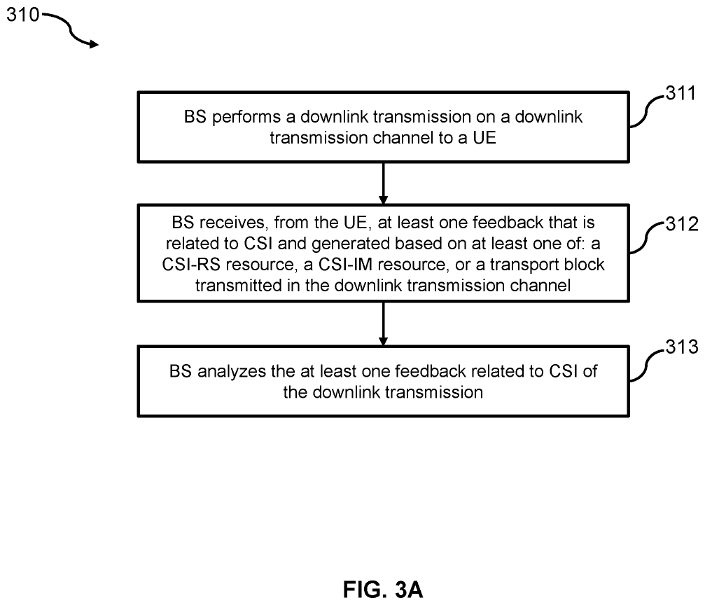

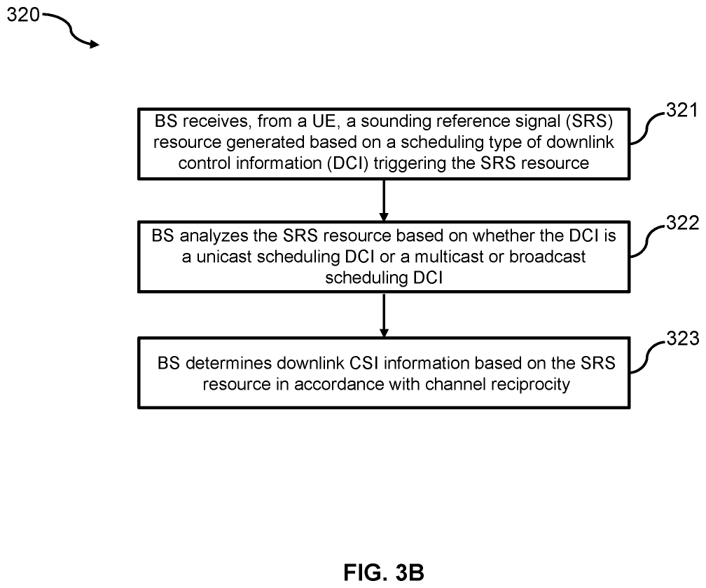

FIG. 3A illustrates a flow chart for a method 310 performed by a BS, e.g. the BS 200 in FIG. 2, for channel quality feedback, in accordance with some embodiments of the present disclosure. At operation 311, the BS performs a downlink transmission on a downlink transmission channel to a UE. At operation 312, the BS receives, from the UE, at least one feedback related to CSI, where the at least one feedback is generated based on at least one of: a CSI-RS resource, a CSI-IM resource, or a transport block transmitted in the downlink transmission channel. At operation 313, the BS analyzes the at least one feedback related to CSI of the downlink transmission. The order of the operations shown in FIG. 3A may be changed according to different embodiments of the present disclosure.

FIG. 3B illustrates a flow chart for another method 320 performed by a BS, e.g. the BS 200 in FIG. 2, for channel quality feedback, in accordance with some embodiments of the present disclosure. At operation 321, the BS receives, from a UE, a sounding reference signal (SRS) resource generated based on a scheduling type of downlink control information (DCI) triggering the SRS. At operation 322, the BS analyzes the SRS resource based on whether the DCI is a unicast scheduling DCI or a multicast or broadcast scheduling DCI. At operation 323, the BS determines downlink CSI information based on the SRS resource in accordance with channel reciprocity. The order of the operations shown in FIG. 3B may be changed according to different embodiments of the present disclosure.

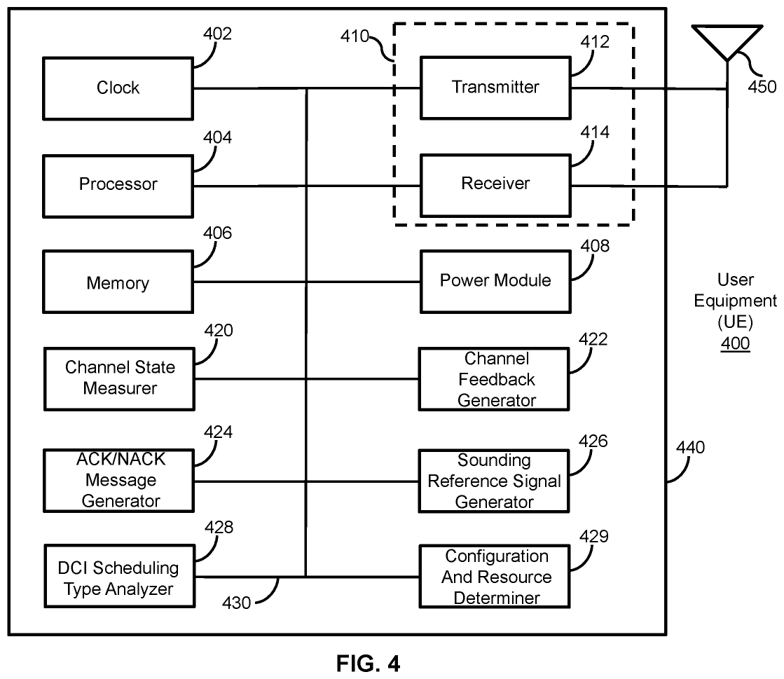

FIG. 4 illustrates a block diagram of a UE 400, in accordance with some embodiments of the present disclosure. The UE 400 is an example of a device that can be configured to implement the various methods described herein. As shown in FIG. 4, the UE 400 includes a housing 440 containing a system clock 402, a processor 404, a memory 406, a transceiver 410 comprising a transmitter 412 and a receiver 414, a power module 408, a channel state measurer 420, a channel feedback generator 422, an ACK/NACK message generator 424, a sounding reference signal generator 426, a DCI scheduling type analyzer 428, and a configuration and resource determiner 429.

In this embodiment, the system clock 402, the processor 404, the memory 406, the transceiver 410 and the power module 408 work similarly to the system clock 202, the processor 204, the memory 206, the transceiver 210 and the power module 208 in the BS 200. An antenna 450 or a multi-antenna array 450 is typically attached to the housing 440 and electrically coupled to the transceiver 410.

The channel state measurer 420 in this example may perform a measurement based on at least one of: a channel state information reference signal (CSI-RS) resource, a channel state information interference measurement (CSI-IM) resource, or a transport block transmitted in a downlink transmission channel from a BS. The channel feedback generator 422 in this example can generate at least one feedback related to channel state information (CSI) based on the measurement; and transmit, via the transmitter 412, the at least one feedback to the BS.

In one embodiment, the ACK/NACK message generator 424 in this example can generate a hybrid automatic repeat request acknowledgement (HARQ-ACK) message in response to the downlink transmission transport block on the downlink transmission channel. In one embodiment, the at least one feedback is generated based on the HARQ-ACK message. In one embodiment, the at least one feedback has a type that is selected from a plurality of types based on content of the HARQ-ACK message. In one embodiment, the at least one feedback has a first type when the HARQ-ACK message has a first content; and the at least one feedback has a second type when the HARQ-ACK message has a second content. In one embodiment, the first content is acknowledgement (ACK); and the second content is negative acknowledgement (NACK).

In one embodiment, the first type corresponds to at least one of the following feedbacks: a degree to which a decoding of the downlink transmission is correct; a recommended modulation coding scheme (MCS); a differential MCS between a recommended MCS and a scheduled MCS; a recommended channel quality indicator (CQI); a differential CQI between a recommended CQI and a scheduled CQI; a recommended pre-coding matrix indicator (PMI); a differential PMI between a recommended PMI and a scheduled PMI; a recommended rank indicator (RI); a recommended beam index; a recommended transmission configuration indication (TCI) state; a recommended CSI-RS resource indicator; a recommended synchronization signal block (SSB) index; a recommended frequency domain index that is used or not used by the BS; or an indication indicating whether to trigger a new CSI feedback by the BS. In one embodiment, the second type corresponds to at least one of the following feedbacks: a degree to which a decoding of the downlink transmission is incorrect; a recommended modulation coding scheme (MCS); a differential MCS between a recommended MCS and a scheduled MCS; a recommended channel quality indicator (CQI); a differential CQI between a recommended CQI and a scheduled CQI; a recommended pre-coding matrix indicator (PMI); a differential PMI between a recommended PMI and a scheduled PMI; a recommended rank indicator (RI); a recommended beam index; a recommended transmission configuration indication (TCI) state; a recommended CSI-RS resource indicator; a recommended synchronization signal block (SSB) index; or a recommended frequency domain index that is used or not used by the BS.

In one embodiment, when the HARQ-ACK message corresponds to one transport block transmitted in physical downlink shared channel (PDSCH), the at least one feedback is one feedback generated based on the transport block transmitted in the PDSCH corresponding to the HARQ-ACK message. In another embodiment, when the HARQ-ACK message corresponds to a plurality of transport blocks transmitted in one or multiple PDSCHs associated with a HARQ-ACK codebook, the at least one feedback comprises one of: one feedback generated based on an ACK or NACK, in the HARQ-ACK message, corresponding to a last transport block transmitted in PDSCH corresponding to the HARQ-ACK codebook; one feedback generated based on an ACK or NACK, in the HARQ-ACK message, corresponding to a transport block transmitted in PDSCH last among the plurality of transport blocks corresponding to the HARQ-ACK codebook before transmitting the at least one feedback; one feedback generated based on a last NACK corresponding to the HARQ-ACK codebook, in the HARQ-ACK message, when the HARQ-ACK message comprises NACK; one feedback generated based on a NACK, in the HARQ-ACK message, corresponding to a transport block transmitted in PDSCH last among the plurality of transport blocks corresponding to the HARQ-ACK codebook before transmitting the at least one feedback, when the HARQ-ACK message comprises NACK; one feedback generated based on a last ACK corresponding to the HARQ-ACK codebook, in the HARQ-ACK message, when the HARQ-ACK message comprises no NACK; one feedback generated based on an ACK, in the HARQ-ACK message, corresponding to a transport block transmitted in PDSCH last among the plurality of transport blocks corresponding to the HARQ-ACK codebook before transmitting the at least one feedback, when the HARQ-ACK message comprises no NACK; one feedback generated based on a transport block transmitted in PDSCH having a worst CSI among the plurality of transport blocks, when the HARQ-ACK message comprises no NACK; one feedback generated based on a transport block transmitted in PDSCH having a worst CSI among the plurality of transport blocks corresponding to all NACKs in the HARQ-ACK message, when the HARQ-ACK message comprises multiple NACKs; one feedback generated based on an average CSI of transport blocks transmitted in PDSCHs corresponding to all NACKs in the HARQ-ACK message, when the HARQ-ACK message comprises multiple NACKs; or a plurality of feedbacks each of which corresponds to a respective transport block transmitted in PDSCH among the plurality of PDSCHs and is generated based on an ACK or NACK, in the HARQ-ACK message, corresponding to the respective PDSCH.

In one embodiment, performing the measurement by the channel state measurer 420 comprises: selecting at least one CSI-RS occasion, and performing a channel measurement filtering based on the at least one CSI-RS occasion. In one embodiment, generating the at least one feedback by the channel feedback generator 422 comprises: calculating a channel quality value based on the channel measurement filtering, and generating the at least one feedback based on the channel quality value. In one embodiment, the at least one CSI-RS occasion is selected based on at least one of the following: all CSI-RS occasions no later than a reference resource of the at least one feedback(e.g. a CSI reference resource associated with a CSI resource setting, and the CSI resource setting is related to the at least one feedback); CSI-RS occasions with channel peak values, among all CSI-RS occasions no later than the reference resource of the at least one feedback, wherein each channel peak value is a maximum value or a value larger than a threshold determined based on a semi-static configuration by the BS or based on a system pre-definition; CSI-RS occasions with channel peak values, among all CSI-RS occasions no later than the reference resource of the at least one feedback, wherein each channel peak value is determined based on: an average channel value calculated based on channel values measured on all CSI-RS occasions before the reference resource, and a threshold determined based on a semi-static configuration by the BS or based on a system pre-definition, where a channel peak value is a channel value larger than the average channel value by a difference value larger than or equal to the threshold; CSI-RS occasions with top N channel values, among all CSI-RS occasions no later than the reference resource of the at least one feedback, wherein N is a positive integer determined based on a semi-static configuration by the BS or based on a system pre-definition; CSI-RS occasions with channel valley values, among all CSI-RS occasions no later than the reference resource of the at least one feedback, wherein each channel valley value is a minimum value or a value smaller than a threshold determined based on a semi-static configuration by the BS or based on a system pre-definition; CSI-RS occasions with channel valley values, among all CSI-RS occasions no later than the reference resource of the at least one feedback, wherein each channel valley value is determined based on: an average channel value calculated based on channel values measured on all CSI-RS occasions before the reference resource, and a threshold determined based on a semi-static configuration by the BS or based on a system pre-definition, where a channel valley value is a channel value less than the average channel value by a difference value larger than or equal to the threshold; CSI-RS occasions with bottom M channel values, among all CSI-RS occasions no later than the reference resource of the at least one feedback, wherein M is a positive integer determined based on a semi-static configuration by the BS or based on a system pre-definition; CSI-RS occasions without channel peak values, among all CSI-RS occasions no later than the reference resource of the at least one feedback; CSI-RS occasions without channel valley values, among all CSI-RS occasions no later than the reference resource of the at least one feedback; or latest L CSI-RS occasions among all CSI-RS occasions no later than the reference resource of the at least one feedback, wherein L is a positive integer determined based on a semi-static configuration by the BS or based on a system pre-definition.

In another embodiment, performing the measurement by the channel state measurer 420 comprises: selecting at least one CSI-RS occasion or at least one CSI-IM occasion, and performing an interference measurement filtering based on the at least one CSI-RS occasion or the at least one CSI-IM occasion. In another embodiment, generating the at least one feedback by the channel feedback generator 422 comprises: calculating an interference quality value based on the interference measurement filtering, and generating the at least one feedback based on the interference quality value. In another embodiment, the at least one CSI-RS occasion or the at least one CSI-IM occasion is selected based on at least one of the following: all CSI-RS or CSI-IM occasions no later than a reference resource of the at least one feedback; CSI-RS or CSI-IM occasions with interference peak values, among all CSI-RS or CSI-IM occasions no later than the reference resource of the at least one feedback, wherein each interference peak value is a maximum value or a value larger than a threshold determined based on a semi-static configuration by the BS or based on a system pre-definition; CSI-RS or CSI-IM occasions with interference peak values, among all CSI-RS or CSI-IM occasions no later than the reference resource of the at least one feedback, wherein each interference peak value is determined based on: an average interference value calculated based on interference values measured on all CSI-RS occasions before the reference resource, and a threshold determined based on a semi-static configuration by the BS or based on a system pre-definition, where an interference peak value is an interference value larger than the average interference value by a difference value larger than or equal to the threshold; CSI-RS or CSI-IM occasions with top X interference values, among all CSI-RS or CSI-IM occasions no later than the reference resource of the at least one feedback, wherein X is a positive integer determined based on a semi-static configuration by the BS or based on a system pre-definition; CSI-RS or CSI-IM occasions with interference valley values, among all CSI-RS or CSI-IM occasions no later than the reference resource of the at least one feedback, wherein each interference valley value is a minimum value or a value smaller than a threshold determined based on a semi-static configuration by the BS or based on a system pre-definition; CSI-RS or CSI-IM occasions with interference valley values, among all CSI-RS or CSI-IM occasions no later than the reference resource of the at least one feedback, wherein each interference valley value is determined based on: an average interference value calculated based on interference values measured on all CSI-RS occasions before the reference resource, and a threshold determined based on a semi-static configuration by the BS or based on a system pre-definition, where an interference valley value is an interference value less than the average interference value by a difference value larger than or equal to the threshold; CSI-RS or CSI-IM occasions with bottom Y interference values, among all CSI-RS or CSI-IM occasions no later than the reference resource of the at least one feedback, wherein Y is a positive integer determined based on a semi-static configuration by the BS or based on a system pre-definition; CSI-RS or CSI-IM occasions without interference peak values, among all CSI-RS or CSI-IM occasions no later than the reference resource of the at least one feedback; CSI-RS or CSI-IM occasions without interference valley values, among all CSI-RS or CSI-IM occasions no later than the reference resource of the at least one feedback; or latest Z CSI-RS or CSI-IM occasions among all CSI-RS or CSI-IM occasions no later than the reference resource of the at least one feedback, wherein Z is a positive integer determined based on a semi-static configuration by the BS or based on a system pre-definition.

In one embodiment, the at least one feedback is generated based on a scheduling type of downlink control information (DCI) triggering the at least one feedback. The DCI scheduling type analyzer 428 in this example can analyze the DCI scheduling type to determine whether the DCI is a unicast scheduling DCI or a multicast or broadcast scheduling DCI, e.g. based on at least one of: a radio network temporary identifier (RNTI) scrambling the DCI, a DCI format in which the DCI is transmitted, a DMRS type of the DCI (different DMRS types can be defined by different DMRS pattern or different DMRS sequence), or a pre-determined field of the DCI. In one embodiment, when the DCI is a unicast scheduling DCI, the configuration and resource determiner 429 selects a first configuration for the at least one feedback from CSI feedback configurations for unicast, based on an indication of a CSI feedback triggering field in the DCI; and when the DCI is a multicast or broadcast scheduling DCI, the configuration and resource determiner 429 selects a second configuration for the at least one feedback from CSI feedback configurations for multicast or broadcast, based on an indication of a CSI feedback triggering field in the DCI. The CSI feedback configurations for unicast, multicast or broadcast may be determined based on a semi-static configuration by the BS or based on a system pre-definition.

In another embodiment, when the DCI is a unicast scheduling DCI, the configuration and resource determiner 429 determines a physical uplink control channel (PUCCH) resource for transmitting the at least one feedback, based on a first method; and when the DCI is a multicast or broadcast scheduling DCI, the configuration and resource determiner 429 determines a physical uplink control channel (PUCCH) resource for transmitting the at least one feedback, based on a second method different from the first method. The first and second methods may be determined based on a semi-static configuration by the BS or based on a system pre-definition.

The sounding reference signal generator 426 in this example can generate a sounding reference signal (SRS) resource based on a scheduling type of downlink control information (DCI) triggering the SRS resource from a BS. The DCI scheduling type analyzer 428 may determine whether the DCI is a unicast scheduling DCI or a multicast or broadcast scheduling DCI, e.g. based on at least one of: a radio network temporary identifier (RNTI) scrambling the DCI, a DCI format in which the DCI is transmitted, a DMRS type of the DCI (different DMRS types can be defined by different DMRS pattern or different DMRS sequence), or a pre-determined field of the DCI. In one embodiment, when the DCI is a unicast scheduling DCI, the configuration and resource determiner 429 selects a first SRS resource group from SRS resource groups for antenna switching based on unicast, based on an indication of a SRS triggering field in the DCI; when the DCI is a multicast or broadcast scheduling DCI, the configuration and resource determiner 429 selects a second SRS resource group from SRS resource groups for antenna switching based on multicast or broadcast, based on an indication of a SRS triggering field in the DCI. The SRS resource may be transmitted, via the transmitter 412, to the BS according to the selected SRS resource group, by either the sounding reference signal generator 426 or the configuration and resource determiner 429. The SRS resource groups for antenna switching based on unicast, multicast or broadcast are determined based on a semi-static configuration by the BS or based on a system pre-definition.

The various modules discussed above are coupled together by a bus system 430. The bus system 430 can include a data bus and, for example, a power bus, a control signal bus, and/or a status signal bus in addition to the data bus. It is understood that the modules of the UE 400 can be operatively coupled to one another using any suitable techniques and mediums.

Although a number of separate modules or components are illustrated in FIG. 4, persons of ordinary skill in the art will understand that one or more of the modules can be combined or commonly implemented. For example, the processor 404 can implement not only the functionality described above with respect to the processor 404, but also implement the functionality described above with respect to the channel state measurer 420. Conversely, each of the modules illustrated in FIG. 4 can be implemented using a plurality of separate components or elements.

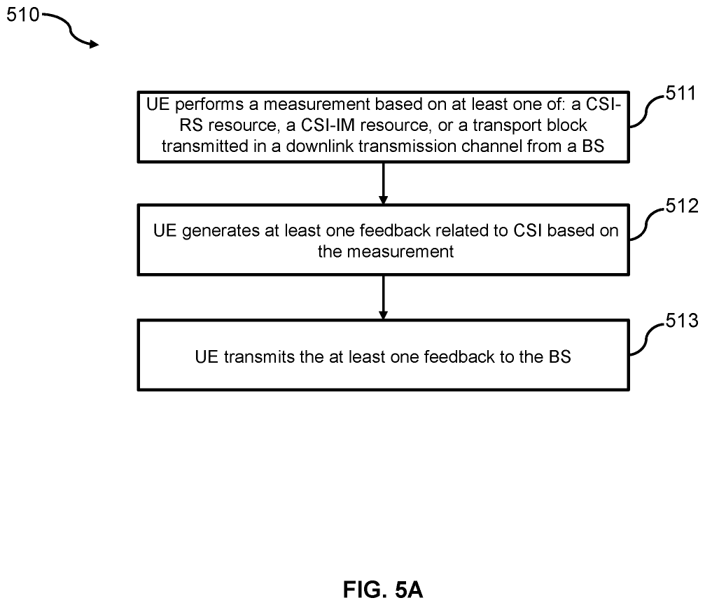

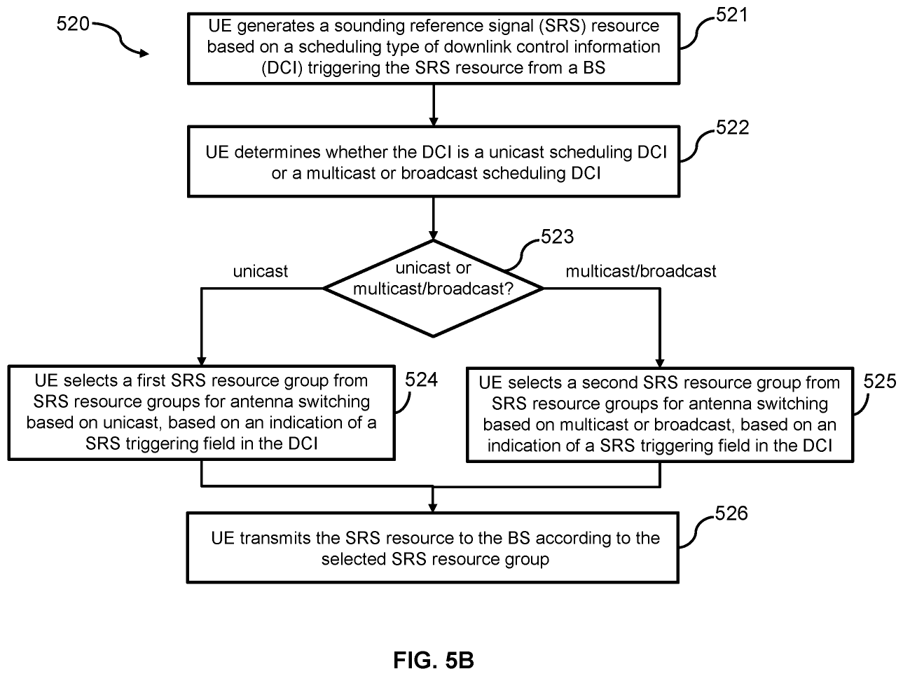

FIG. 5A illustrates a flow chart for a method 510 performed by a UE, e.g. the UE 400 in FIG. 4, for channel quality feedback, in accordance with some embodiments of the present disclosure. At operation 511, the UE performs a measurement based on at least one of: a CSI-RS resource, a CSI-IM resource, or a transport block transmitted in a downlink transmission channel from a BS. At operation 512, the UE generates at least one feedback related to CSI based on the measurement. At operation 513, the UE transmits the at least one feedback to the BS. The order of the operations shown in FIG. 5A may be changed according to different embodiments of the present disclosure.

FIG. 5B illustrates a flow chart for another method 520 performed by a UE, e.g. the UE 400 in FIG. 4, for channel quality feedback, in accordance with some embodiments of the present disclosure. At operation 521, the UE generates a sounding reference signal (SRS) resource based on a scheduling type of downlink control information (DCI) triggering the SRS resource from a BS. At operation 522, the UE determines whether the DCI is a unicast scheduling DCI or a multicast or broadcast scheduling DCI. At operation 523, if the UE determines that the DCI is a unicast scheduling DCI, the process moves on to operation 524; and if the UE determines that the DCI is a multicast or broadcast scheduling DCI, the process moves on to operation 525.

At operation 524, the UE selects a first SRS resource group from SRS resource groups for antenna switching based on unicast, based on an indication of a SRS triggering field in the DCI. Then the process moves on to operation 526.

At operation 525, the UE selects a second SRS resource group from SRS resource groups for antenna switching based on multicast or broadcast, based on an indication of a SRS triggering field in the DCI. Then the process moves on to operation 526 as well.

At operation 526, the UE transmits the SRS resource to the BS according to the selected SRS resource group, which is either the first SRS resource group or the second SRS resource group. The order of the operations shown in FIG. 5B may be changed according to different embodiments of the present disclosure.

Different embodiments of the present disclosure will now be described in detail hereinafter. It is noted that the features of the embodiments and examples in the present disclosure may be combined with each other in any manner without conflict.

In a first embodiment, different channel feedbacks are generated corresponding to ACK and NACK respectively. In this embodiment, a terminal feeds back the channel information, e.g. CSI, associated with the HARQ-ACK feedback according to a system pre-definition or a semi-static configuration of the BS or a dynamic indication of the base station. When the HARQ-ACK feedback indicates that the PDSCH transport block decoding is correct, the associated CSI feedback indicates a first information type. When the HARQ-ACK feedback indicates that the PDSCH transport block decoding is incorrect, the associated CSI feedback indicates a second information type.

The first information type may include at least one of the following: (1) a degree to which PDSCH transport block decoding is correct; (2) recommended MCS level, CQI, PMI, RI, or beam index; (3) recommended frequency domain index; or (4) The CSI reports triggering requirements. These four information types can be used together.

For type (1), the terminal determines that the PDSCH transport block decoding result is correct. Specifically, the decoding result can be divided into multiple levels, indicating the correctness degree from low to high. Different feedback states indicate different decoding correctness levels.

For type (2), while the terminal determines that the PDSCH transport block decoding result is correct, it compares the information obtained during the decoding process with the PDSCH scheduling information, such as MCS, RI, TPMI (transmitted precoding matrix indicator) and TCI state, obtained by the base station. It is considered that the base station can further optimize the PDSCH scheduling or there is no need for further optimization. Therefore, the terminal feeds back an optimal value to the base station. In this manner, during the subsequent scheduling, the BS can perform better link self-adaptation by referring to the recommended value reported by the UE. The recommended values can be: MCS level, CQI, RI, PMI, TCI state, CRI (CSI-RS resource indicator) and/or SSB index. The recommended value can be a non-differential value or a difference value. If it is a non-differential value, the optimal value is the value recommended by the UE. If it is a difference value, the optimal value is the difference between the recommended value of the UE and the value used by the BS to schedule the PDSCH, or the difference between the recommended value of the UE and the latest feedback value of the UE. For example, the difference value may be any one of: a differential MCS between a recommended MCS and a scheduled MCS, a differential CQI between a recommended CQI and a scheduled CQI, or a differential PMI between a recommended PMI and the scheduled PMI.

There may be multiple feedback states, corresponding to different types of recommended values. For example, state 1 indicates that no adjustment is needed; state 2 indicates that the MCS needs to be adjusted; state 3 indicates that the RI needs to be adjusted; state 4 indicates that the TPMI needs to be adjusted; state 5 indicates that the TCI state, i.e. the BS transmitting beam direction, needs to be adjusted. The meanings of different states are predefined in the system or configured in semi-static mode.

Different feedback states can also correspond to different recommended values of the same type. For example, state 1 indicates that the MCS needs to be adjusted in accordance with the recommended value 1; state 2 indicates that the MCS needs to be adjusted in accordance with the recommended value 2; and state 3 indicates that the MCS needs to be adjusted in accordance with the recommended value 3. The corresponding relationship between the recommended values to the feedback states may be based on a pre-definition of the system, a semi-static configuration, or a dynamic indication.

For type (3), the UE performs channel measurement for multiple frequency domain units, where the channel measurement can be based on CSI-RS resource, the demodulation reference signal (DMRS) of the PDSCH or the demodulation of PDSCH. According to the channel measurement result, the channel quality of some frequency domain units may be considered better. Therefore, the UE feeds back the indexes of these frequency domain units to the base station, so that the base station can schedule PDSCH transmission on these frequency domain units or not on these frequency domain units. The frequency domain unit indexes may be: carrier indexes, bandwidth part (BWP) indexes, subband indexes, resource block group (RBG) indexes, and/or physical resource block (PRB) indexes.

For type (4), the CSI feedback can be aperiodic CSI feedback, periodic CSI feedback or semi-persistent CSI feedback. When the BS continues link self-adaptation based on the previous CSI, the previous CSI cannot match well the current channel quality. Therefore, the terminal determines whether to trigger a new aperiodic CSI feedback or activate a new semi-persistent CSI feedback or periodic CSI feedback. The feedback may correspond to sub-bands same as or different from the sub-band of the current PDSCH, and/or carriers same as or different from the carrier of the current PDSCH. The feedback can have multiple feedback states. For example, state 1 indicates no new CSI feedback is triggered or activated; state 2 indicates that new CSI feedback is triggered or activated. Further, there may be one or more states in which a new CSI is to be triggered or activated. For example, state 2 indicates that a first CSI feedback is triggered or activated; and state 3 indicates that a second CSI feedback is triggered or activated.

The first CSI feedback and the second CSI feedback can correspond to different CSI feedback types. For example, the first CSI feedback indicates aperiodic CSI feedback, and the second CSI feedback indicates semi-persistent CSI feedback.

The first CSI feedback and the second CSI feedback can correspond to different feedback configurations, e.g. different CSI Report configurations. For example, the first CSI feedback corresponds to CSI Report config #0, and the second CSI feedback corresponds to CSI Report config #1.

The first CSI feedback and the second CSI feedback can correspond to different measurement resources, e.g., different CSI-RS Resource settings, different CSI-RS Resource sets, different CSI-RS Resources, different CSI-IM Resource settings, different CSI-IM Resource sets, and/or different CSI-IM Resources.

After receiving the feedback from the terminal, the BS can trigger or activate the CSI feedback proposed by the terminal according to the feedback. Alternatively, after receiving the feedback from the terminal, the BS can directly send the CSI-RS or CSI-IM suggested by the terminal according to the feedback. In this way, the terminal can directly perform measurement and feed back the CSI based on the measurement result without be triggered the CSI feedback by the BS additionally.

The second information type may include at least one of the following: (5) PDSCH transport block decoding error degree; (6) recommended MCS level, CQI, PMI, RI, or beam index; or (7) recommended frequency domain index. For type (5), the UE determines that the PDSCH transport block decoding result is a decoding error. Specifically, the decoding error can be divided into multiple levels, from low to high, indicating the error degree from low to high. Different feedback states indicate different levels of decoding errors, respectively.

In one embodiment, the first information type is different from the second information type. Then the BS should first receive and decode the HARQ-ACK feedback, and determine whether the CSI feedback associated with the HARQ-ACK feedback indicates the first information type or the second information type. After the information type indicated by the CSI feedback is determined, the specific description of the feedback state can be determined in accordance with the CSI feedback decoding result.

In a second embodiment, different associations between the CSI feedback and the HARQ-ACK feedback are discussed. As discussed above, the CSI feedback is associated with the HARQ-ACK feedback. The BS and the terminal can determine the associated CSI feedback corresponding to the HARQ-ACK feedback in one of the following manners.

In one situation, when the HARQ-ACK feedback contains only the HARQ-ACK feedback bit corresponding to one PDSCH transport block, if the CSI carried in the feedback is obtained based on the PDSCH transport block, the CSI feedback is obtained based on the PDSCH transport block corresponding to the HARQ-ACK feedback.

In another situation, when the HARQ-ACK feedback is based on a dynamic codebook and includes the HARQ-ACK feedback bits corresponding to multiple PDSCH transport blocks, the terminal returns one associated CSI feedback corresponding to one HARQ-ACK codebook. If the CSI carried in the CSI feedback is obtained based on the PDSCH transport block, the CSI feedback is obtained based on one or more PDSCH transport blocks corresponding to the HARQ-ACK codebook. Based on a system pre-definition, a semi-static BS configuration or a BS dynamic indication, the CSI feedback is obtained based on exactly which one or more PDSCH transport blocks corresponding to the HARQ-ACK codebook can be determined by at least one of the following methods or manners.

In one manner, the CSI feedback is always obtained according to the last PDSCH transport block in the PDSCHs corresponding to the HARQ-ACK codebook. If the HARQ-ACK feedback of the last PDSCH transport block is ACK, the CSI feedback indicates the first information type. If the HARQ-ACK feedback of the last PDSCH transport block is NACK, the CSI feedback indicates the second information type. The last PDSCH transport block refers to a PDSCH transport block that is closest to the CSI feedback time among all PDSCH transport blocks meeting the conditions.

In one manner, if the HARQ-ACK codebook contains NACK feedback, the CSI feedback indicates the second information type, and the CSI feedback is obtained according to the PDSCH transport block corresponding to the last NACK feedback corresponding to the HARQ-ACK codebook. The last NACK refers to a NACK corresponding to a PDSCH transport block that is closest to the CSI feedback time among all PDSCH transport blocks meeting the conditions.

In one manner, if the HARQ-ACK codebook does not contain NACK feedback, the CSI feedback indicates the first information type, and the CSI feedback is obtained according to the PDSCH transport block corresponding to the last ACK feedback corresponding to the HARQ-ACK codebook. The last ACK refers to a ACK corresponding to a PDSCH transport block that is closest to the CSI feedback time among all PDSCH transport blocks meeting the conditions.

In one manner, if the HARQ-ACK codebook does not contain NACK feedback, the CSI feedback indicates the first information type, and the CSI feedback is obtained according to all PDSCH transport blocks corresponding to the HARQ-ACK codebook. The CSI feedback can be based on a maximum or minimum CSI obtained for each PDSCH transport block, reflecting a worst channel quality. After receiving the CSI feedback, the B S can perform the most conservative link self-adaptive adjustment to improve PDSCH transmission reliability.

In one manner, if the HARQ-ACK codebook contains multiple NACK feedbacks, the CSI feedback indicates the second information type, and the CSI feedback is obtained according to all PDSCH transport blocks corresponding to NACK feedbacks corresponding to the HARQ-ACK codebook. Specifically, the CSI feedback can be based on a maximum or minimum CSI obtained in accordance with each PDSCH transport block corresponding to each NACK, reflecting the worst channel quality. After receiving the CSI feedback, the BS can perform the most conservative link self-adaptive adjustment to improve PDSCH transport block transmission reliability.

In one manner, if the HARQ-ACK codebook contains multiple NACK feedbacks, the CSI feedback indicates the second information type, and the CSI feedback is obtained according to all PDSCH transport blocks corresponding to NACK feedbacks in the HARQ-ACK codebook. The CSI feedback can be based on an average CSI obtained in accordance with the PDSCH transport block corresponding to each NACK feedback, to reflect an average channel quality.

In one situation, when the HARQ-ACK feedback is based on the dynamic codebook and contains the HARQ-ACK feedback bits corresponding to multiple PDSCH transport blocks, the terminal will feed back multiple CSI feedbacks, each of which corresponds to one of the multiple PDSCH transport blocks in the HARQ-ACK codebook. There is a one-to-one mapping between the PDSCH transport blocks in the HARQ-ACK codebook and the associated CSI feedbacks. Whether each associated CSI feedback is of the first information type or the second information type depends on whether the HARQ-ACK feedback of the corresponding PDSCH transport block is ACK or NACK. If the HARQ-ACK feedback of the corresponding PDSCH transport block is ACK, the associated CSI feedback indicates the first information type. If the HARQ-ACK feedback of the corresponding PDSCH transport block is NACK, the associated CSI feedback indicates the second information type.

In a third embodiment, the BS can configure an interference measurement filtering to control interference estimation. The values and/or quantities contained in the CSI feedback can be configured by the BS semi-statically. When the CSI feedback contains channel state information like CQI, the BS will configure CSI-RS resources for the terminal to measure channel, and configure CSI-RS or CSI-IM resources for the terminal to measure interference. In addition, the BS will further configure whether filtering is enabled for channel measurement and whether filtering is enabled for interference measurement. The UE calculates the CQI or other CSI feedback values and quantities in accordance with the measured channels and interference.

To enable the BS to control the CSI feedback (e.g. CQI feedback) of UEs, the BS can configure conditions for selecting resources for performing channel measurement filtering and/or interference measurement filtering. The detailed configurations may include at least one of the following conditions.

When enabling channel measurement filtering, the BS can further configure filtering conditions for selecting CSI-RS occasions to participate in filtering. When enabling interference measurement filtering, the BS can further configure filtering conditions for selecting CSI-RS occasions or CSI-IM occasions to participate in filtering. The above mentioned filtering conditions may include at least one of the following conditions.

According to one condition, the channel measurement filtering can be based on all CSI-RS occasions no later than the reference resource of the CSI feedback. According to one condition, the interference measurement filtering can be based on all CSI-RS occasions or CSI-IM occasions no later than the reference resource of the CSI feedback.

According to one condition, the channel measurement filtering can be based on the CSI-RS occasions where channel peak values are measured, among all CSI-RS occasions no later than the reference resource of the CSI feedback. The channel peak value is a maximum value or a value larger than a threshold determined based on a semi-static configuration by the BS or based on a system pre-definition.

According to one condition, a threshold with value a is determined based on a semi-static configuration by the BS or based on a system pre-definition for channel peak judgment. The channel measurement filtering can be based on some CSI-RS occasions, for each of which the channel value is larger, by at least the threshold value a, than an average channel value measured at multiple CSI-RS occasions. A CSI-RS occasion that meets this condition may be called a CSI-RS occasion with channel peak value.

According to one condition, the number of CSI-RS occasions for channel peak judgment can be number x, based on a semi-static configuration by the BS or based on a system pre-definition. After sorting the measured channel value on each CSI-RS occasion in descending order, the CSI-RS occasions corresponding to the first x channel values or the greatest x channel values, can be called the CSI-RS occasions with channel peak values.

According to one condition, the interference measurement filtering can be based on the CSI-RS or CSI-IM occasions where interference peak values are measured, among all CSI-RS or CSI-IM occasions no later than the reference resource of the CSI feedback. The interference peak value is a maximum value or a value larger than a threshold determined based on a semi-static configuration by the BS or based on a system pre-definition.

According to one condition, a threshold with value b is determined based on a semi-static configuration by the BS or based on a system pre-definition for interference peak judgment. The interference measurement filtering can be based on some CSI-RS occasions or CSI-IM occasions, for each of which the interference value is larger, by at least the threshold value b, than an average interference value measured at multiple CSI-RS occasions. A CSI-RS occasion or CSI-IM occasion that meets this condition may be called a CSI-RS occasion or CSI-IM occasion with interference peak value.

According to one condition, the number of CSI-RS occasions or CSI-IM occasions for interference peak judgment can be number y, based on a semi-static configuration by the BS or based on a system pre-definition. After sorting the measured interference value on each CSI-RS occasion or CSI-IM occasion in descending order, the CSI-RS occasions or CSI-IM occasions corresponding to the first y interference values or the greatest y interference values, can be called the CSI-RS occasions or CSI-IM occasions with interference peak values.

According to one condition, the channel measurement filtering can be based on the CSI-RS occasions where channel valley values are measured, among all CSI-RS occasions no later than the reference resource of the CSI feedback. The channel valley value is a minimum value or a value smaller than a threshold determined based on a semi-static configuration by the BS or based on a system pre-definition.

According to one condition, a threshold with value c is determined based on a semi-static configuration by the BS or based on a system pre-definition for channel valley judgment. The channel measurement filtering can be based on some CSI-RS occasions, for each of which the channel value is smaller, by at least the threshold value c, than an average channel value measured at multiple CSI-RS occasions. A CSI-RS occasion that meets this condition may be called a CSI-RS occasion with channel valley value.

According to one condition, the number of CSI-RS occasions for channel valley judgment can be number p, based on a semi-static configuration by the BS or based on a system pre-definition. After sorting the measured channel value on each CSI-RS occasion in ascending order, the CSI-RS occasions corresponding to the first p channel values or the smallest p channel values, can be called the CSI-RS occasions with channel valley values.

According to one condition, the interference measurement filtering can be based on the CSI-RS or CSI-IM occasions where interference valley values are measured, among all CSI-RS or CSI-IM occasions no later than the reference resource of the CSI feedback. The interference valley value is a minimum value or a value smaller than a threshold determined based on a semi-static configuration by the BS or based on a system pre-definition.

According to one condition, a threshold with value d is determined based on a semi-static configuration by the BS or based on a system pre-definition for interference valley judgment. The interference measurement filtering can be based on some CSI-RS occasions or CSI-IM occasions, for each of which the interference value is smaller, by at least the threshold value d, than an average interference value measured at multiple CSI-RS occasions. A CSI-RS occasion or CSI-IM occasion that meets this condition may be called a CSI-RS occasion or CSI-IM occasion with interference valley value.

According to one condition, the number of CSI-RS occasions or CSI-IM occasions for interference valley judgment can be number q, based on a semi-static configuration by the BS or based on a system pre-definition. After sorting the measured interference value on each CSI-RS occasion or CSI-IM occasion in ascending order, the CSI-RS occasions or CSI-IM occasions corresponding to the first q interference values or the smallest q interference values, can be called the CSI-RS occasions or CSI-IM occasions with interference valley values.

According to one condition, the channel measurement filtering can be based on the CSI-RS occasions where channel peak values are not measured, among all CSI-RS occasions no later than the reference resource of the CSI feedback.

According to one condition, the interference measurement filtering can be based on the CSI-RS occasions or the CSI-IM occasions where interference peak values are not measured, among all CSI-RS occasions or CSI-IM occasions no later than the reference resource of the CSI feedback

According to one condition, the channel measurement filtering can be based on the recent or latest n CSI-RS occasions, which are no later than the reference resource of the CSI feedback. The n can be a positive integer determined based on a semi-static configuration by the BS or based on a system pre-definition. The recent or latest here means closest to the CSI feedback time.

According to one condition, the interference measurement filtering can be based on the recent or latest m CSI-RS occasions, which are no later than the reference resource of the CSI feedback. The m can be a positive integer determined based on a semi-static configuration by the BS or based on a system pre-definition. The recent or latest here means closest to the CSI feedback time.

In one example, according to the configuration from the BS, the terminal selects the CSI-RS occasions that meet the conditions to participate in the channel measurement filtering, calculates the CQI or other CSI feedback quantity based on the channel measurement filtering with selected CSI-RS occasions, and transmits the calculated feedback quantity in the CSI feedback to the BS.

In one example, according to the configuration from the BS, the terminal selects the CSI-RS occasions or CSI-IM occasions that meet the conditions to participate in the interference measurement filtering, calculates the CQI or other CSI feedback quantity based on the interference measurement filtering with selected CSI-RS occasions or CSI-IM occasions, and then transmits the calculated feedback quantity in the CSI feedback to the BS.

In a fourth embodiment, CSI feedback is enhanced under a Multicast or Broadcast System (MBS). If a terminal supports unicast and multicast/broadcast services, the CSI feedback contents and measurement resources for the link self-adaptation regarding unicast transmission and multicast/broadcast transmission may be different. Therefore, the BS can further configure one or more sets of semi-static CSI feedback configurations to UE for multicast/broadcast transmission link self-adaptation.

When the DCI that triggers CSI is unicast scheduling DCI, the UE searches for the corresponding CSI feedback configuration in the conventional CSI feedback configurations, in accordance with the indication of the CSI feedback triggering field in the DCI. The CSI feedback configuration may be associated with measurement resources.

When the DCI that triggers CSI is multicast/broadcast scheduling DCI, the UE searches for the corresponding CSI feedback configuration in the CSI feedback configurations for multicast/broadcast link adaptation, in accordance with the indication of the CSI feedback triggering field in the DCI. The CSI feedback configuration may be associated with measurement resources.

The UE can determine whether the DCI is a unicast scheduling DCI or a multicast/broadcast scheduling DCI based on the RNTI of the DCI. When the DCI is scrambled with C-RNTI, the DCI is unicast scheduling DCI. When the DCI is scrambled with group-RNTI, the DCI is multicast/broadcast scheduling DCI. The terminal can also determine whether the DCI is a unicast scheduling DCI or a multicast/broadcast scheduling DCI in accordance with a field of the DCI.

In a fifth embodiment, SRS measurement is enhanced under MBS. In a time division duplex (TDD) scenario, the BS can obtain downlink channel CSI information based on the SRS resource sent by a UE, in accordance with channel reciprocity. Similar to the fourth embodiment, if the terminal supports unicast and multicast/broadcast services, the SRS resource transmissions for antenna switching under unicast transmission may differ from that under multicast/broadcast transmission in terms of SRS resource configuration. Therefore, the base station can configure one or more sets of semi-static SRS resource groups for antenna switching in multicast/broadcast transmission.

When the DCI that triggers SRS resource is a unicast scheduling DCI, the UE selects the corresponding SRS resource group from the conventional SRS resource groups, in accordance with the indication of the SRS triggering field in the DCI, and sends SRS resource in accordance with the selected SRS resource group.

When the DCI that triggers SRS resource is a multicast/broadcast scheduling DCI, the UE selects the corresponding SRS resource group from the SRS resource groups applied to the antenna switching in multicast/broadcast transmission, in accordance with the indication of the SRS triggering field in the DCI, and sends the SRS resource according to the selected SRS resource group.

The UE can determine whether the DCI is a unicast scheduling DCI or a multicast/broadcast scheduling DCI in accordance with the RNTI of the DCI. When the DCI is scrambled with C-RNTI, the DCI is unicast scheduling DCI. When the DCI is scrambled with group-RNTI, the DCI is multicast/broadcast scheduling DCI. The terminal can also determine whether the DCI is a unicast-scheduled DCI or a multicast/broadcast-scheduled DCI in accordance with a field of the DCI.

In a sixth embodiment, PUCCH resources are determined for CSI feedback under MBS. If the CSI feedback is carried on the PUCCH, how to determine CSI PUCCH resources is the problem to be solved. For a terminal that supports both unicast and multi-broadcast services, the feedback methods may be different in CSI self-adaptation for unicast transmission links and multicast/broadcast transmission links.

In one example, CSI PUCCH resources are determined based on a first method for the CSI feedback applied in the self-adaptive unicast transmission link; and CSI PUCCH resources are determined based on a second method for the CSI feedback applied in the self-adaptive multicast/broadcast transmission link. In this example, the terminal determines whether CSI PUCCH resources are based on the first method or based on the second method based on the scheduling type of the DCI that triggers the CSI feedback.

If the DCI received by the terminal for triggering the CSI is a unicast scheduling DCI, the terminal determines the CSI PUCCH resource according to the first method. If the DCI received by the terminal for triggering the CSI is a multicast/broadcast scheduling DCI, the terminal determines the CSI PUCCH resource according to the second method.

The UE can determine whether the DCI is a unicast scheduling DCI or a multicast/broadcast scheduling DCI in accordance with the RNTI of the DCI. When the DCI is scrambled with C-RNTI, the DCI is unicast scheduling DCI. When the DCI is scrambled with group-RNTI, the DCI is multicast/broadcast scheduling DCI. The terminal can also determine whether the DCI is a unicast-scheduled DCI or a multicast/broadcast-scheduled DCI in accordance with a field of the DCI. The CSI feedback can be aperiodic CSI feedback or semi-persistent CSI feedback.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques.

To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, module, etc. can be configured to perform one or more of the functions described herein. The term “configured to” or “configured for” as used herein with respect to a specified operation or function refers to a processor, device, component, circuit, structure, machine, module, etc. that is physically constructed, programmed and/or arranged to perform the specified operation or function.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A method performed by a wireless communication device, the method comprising:
performing a measurement based on at least one of: a channel state information reference signal (CSI-RS) resource, a channel state information interference measurement (CSI-IM) resource, or a transport block transmitted in a downlink transmission channel from a wireless communication node;
generating at least one feedback related to channel state information (CSI) based on the measurement; and
transmitting the at least one feedback to the wireless communication node.

2. The method of claim 1, further comprising:
generating a hybrid automatic repeat request acknowledgement (HARQ-ACK) message in response to a downlink transmission on the downlink transmission channel, wherein:
the at least one feedback is generated based on the HARQ-ACK message, and/or
the at least one feedback has a type that is selected from a plurality of types based on content of the HARQ-ACK message.

3. The method of claim 2, wherein:
the at least one feedback has a first type when the HARQ-ACK message has a first content; and
the at least one feedback has a second type when the HARQ-ACK message has a second content.

4. The method of claim 3, wherein:
the first content is acknowledgement (ACK); and
the second content is negative acknowledgement (NACK).

5. The method of claim 3, wherein the first type corresponds to at least one of the following feedbacks:
a degree to which a decoding of the downlink transmission is correct;
a recommended modulation coding scheme (MCS);
a differential MCS between a recommended MCS and a scheduled MCS;
a recommended channel quality indicator (COI);
a differential CQI between a recommended CQI and a scheduled CQI;
a recommended pre-coding matrix indicator (PMI);
a differential PMI between a recommended PMI and the scheduled PMI;
a recommended rank indicator (RI);
a recommended beam index;
a recommended transmission configuration indication (TCI) state;
a recommended CSI-RS resource indicator;
a recommended synchronization signal block (SSB) index;
a recommended frequency domain index; or
an indication indicating whether to trigger a new CSI feedback by the wireless communication node.

6. The method of claim 3, wherein the second type corresponds to at least one of the following feedbacks:
a degree to which a decoding of the downlink transmission is incorrect;
a recommended modulation coding scheme (MCS);
a differential MCS between a recommended MCS and a scheduled MCS;
a recommended channel quality indicator (COI);
a differential CQI between a recommended CQI and a scheduled CQI;
a recommended pre-coding matrix indicator (PMI);
a differential PMI between a recommended PMI and a scheduled PMI;
a recommended rank indicator (RI);
a recommended beam index;
a recommended transmission configuration indication (TCI) state;
a recommended CSI-RS resource indicator;
a recommended synchronization signal block (SSB) index; or
a recommended frequency domain index.

7. The method of claim 2, wherein when the HARQ-ACK message corresponds to one transport block transmitted in physical downlink shared channel (PDSCH), the at least one feedback is one feedback generated based on the transport block transmitted in PDSCH corresponding to the HARQ-ACK message.

8. The method of claim 2, wherein when the HARQ-ACK message corresponds to a plurality of PDSCHs associated with a HARQ-ACK codebook, the at least one feedback comprises one of:
one feedback generated based on a ACK or NACK, in the HARQ-ACK message, corresponding to a last transport block transmitted in PDSCH corresponding to the HARQ-ACK codebook;
one feedback generated based on a ACK or NACK, in the HARQ-ACK message, corresponding to a transport block transmitted in PDSCH last among the plurality of transport blocks corresponding to the HARQ-ACK codebook before transmitting the at least one feedback;
one feedback generated based on a last NACK corresponding to the HARQ-ACK codebook, in the HARQ-ACK message, when the HARQ-ACK message comprises NACK;
one feedback generated based on a NACK, in the HARQ-ACK message, corresponding to a transport block transmitted in PDSCH last among the plurality of transport blocks corresponding to the HARQ-ACK codebook before transmitting the at least one feedback, when the HARQ-ACK message comprises NACK;
one feedback generated based on a last ACK corresponding to the HARQ-ACK codebook, in the HARQ-ACK message, when the HARQ-ACK message comprises no NACK;
one feedback generated based on an ACK, in the HARQ-ACK message, corresponding to a transport block transmitted in PDSCH last among the plurality of transport blocks corresponding to the HARQ-ACK codebook before transmitting the at least one feedback, when the HARQ-ACK message comprises no NACK;
one feedback generated based on a transport block transmitted in PDSCH having a worst CSI among the plurality of transport blocks, when the HARQ-ACK message comprises no NACK;
one feedback generated based on a transport block transmitted in PDSCH having a worst CSI among the plurality of transport blocks corresponding to all NACKs in the HARQ-ACK message, when the HARQ-ACK message comprises multiple NACKs;
one feedback generated based on an average CSI of transport blocks transmitted in PDSCHs corresponding to all NACKs in the HARQ-ACK message, when the HARQ-ACK message comprises multiple NACKs; or
a plurality of feedbacks each of which corresponds to a respective transport block transmitted in PDSCH among the plurality of PDSCHs and is generated based on a ACK or NACK, in the HARQ-ACK message, corresponding to the respective PDSCH.

9. The method of claim 1, wherein:
performing the measurement comprises:
selecting at least one CSI-RS occasion, and
deriving a channel measurement for computing the at least one feedback based on the at least one CSI-RS occasion;
generating the at least one feedback comprises:
calculating a channel quality value based on the channel measurement, and generating the at least one feedback based on the channel quality value; and
the at least one CSI-RS occasion is selected based on at least one of the following:
all CSI-RS occasions no later than a reference resource of the at least one feedback, CSI-RS occasions with channel peak values, among all CSI-RS occasions no later than the reference resource of the at least one feedback, wherein each channel peak value is a maximum value or a value larger than a threshold determined based on a semi-static configuration by the wireless communication node or based on a system pre-definition,
CSI-RS occasions with channel peak values, among all CSI-RS occasions no later than the reference resource of the at least one feedback, wherein each channel peak value is determined based on: an average channel value, and a threshold determined based on a semi-static configuration by the wireless communication node or based on a system pre-definition,
CSI-RS occasions with top N channel values, among all CSI-RS occasions no later than the reference resource of the at least one feedback, wherein N is a positive integer determined based on a semi-static configuration by the wireless communication node or based on a system pre-definition,
CSI-RS occasions with channel valley values, among all CSI-RS occasions no later than the reference resource of the at least one feedback, wherein each channel valley value is a minimum value or a value smaller than a threshold determined based on a semi-static configuration by the wireless communication node or based on a system pre-definition,
CSI-RS occasions with channel valley values, among all CSI-RS occasions no later than the reference resource of the at least one feedback, wherein each channel valley value is determined based on: an average channel value, and a threshold determined based on a semi-static configuration by the wireless communication node or based on a system pre-definition,
CSI-RS occasions with bottom M channel values, among all CSI-RS occasions no later than the reference resource of the at least one feedback, wherein M is a positive integer determined based on a semi-static configuration by the wireless communication node or based on a system pre-definition,
CSI-RS occasions without channel peak values, among all CSI-RS occasions no later than the reference resource of the at least one feedback,
CSI-RS occasions without channel valley values, among all CSI-RS occasions no later than the reference resource of the at least one feedback, or
latest L CSI-RS occasions among all CSI-RS occasions no later than the reference resource of the at least one feedback, wherein L is a positive integer determined based on a semi-static configuration by the wireless communication node or based on a system pre-definition.

10. The method of claim 1, wherein:
performing the measurement comprises:
selecting at least one CSI-RS occasion or at least one CSI-IM occasion, and
deriving an interference measurement for computing the at least one feedback based on the at least one CSI-RS occasion or the at least one CSI-IM occasion;
generating the at least one feedback comprises:
calculating an interference quality value based on the interference measurement, and
generating the at least one feedback based on the interference quality value; and
the at least one CSI-RS occasion or the at least one CSI-IM occasion is selected based on at least one of the following:
all CSI-RS or CSI-IM occasions no later than a reference resource of the at least one feedback,
CSI-RS or CSI-IM occasions with interference peak values, among all CSI-RS or CSI-IM occasions no later than the reference resource of the at least one feedback, wherein each interference peak value is a maximum value or a value larger than a threshold determined based on a semi-static configuration by the wireless communication node or based on a system pre-definition,
CSI-RS or CSI-IM occasions with interference peak values, among all CSI-RS or CSI-IM occasions no later than the reference resource of the at least one feedback, wherein each interference peak value is determined based on: an average interference value, and a threshold determined based on a semi-static configuration by the wireless communication node or based on a system pre-definition,
CSI-RS or CSI-IM occasions with top X interference values, among all CSI-RS or CSI-IM occasions no later than the reference resource of the at least one feedback, wherein X is a positive integer determined based on a semi-static configuration by the wireless communication node or based on a system pre-definition,
CSI-RS or CSI-IM occasions with interference valley values, among all CSI-RS or CSI-IM occasions no later than the reference resource of the at least one feedback, wherein each interference valley value is a minimum value or a value smaller than a threshold determined based on a semi-static configuration by the wireless communication node or based on a system pre-definition,
CSI-RS or CSI-IM occasions with interference valley values, among all CSI-RS or CSI-IM occasions no later than the reference resource of the at least one feedback, wherein each interference valley value is determined based on: an average interference value, and a threshold determined based on a semi-static configuration by the wireless communication node or based on a system pre-definition,
CSI-RS or CSI-IM occasions with bottom Y interference values, among all CSI-RS or CSI-IM occasions no later than the reference resource of the at least one feedback, wherein Y is a positive integer determined based on a semi-static configuration by the wireless communication node or based on a system pre-definition,
CSI-RS or CSI-IM occasions without interference peak values, among all CSI-RS or CSI-IM occasions no later than the reference resource of the at least one feedback,
CSI-RS or CSI-IM occasions without interference valley values, among all CSI-RS or CSI-IM occasions no later than the reference resource of the at least one feedback, or
latest Z CSI-RS or CSI-IM occasions among all CSI-RS or CSI-IM occasions no later than the reference resource of the at least one feedback, wherein Z is a positive integer determined based on a semi-static configuration by the wireless communication node or based on a system pre-definition.

11. The method of claim 1, wherein:
the at least one feedback is generated based on a scheduling type of downlink control information (DCI) triggering the at least one feedback.

12. The method of claim 11, further comprising:
determining whether the DCI is a unicast scheduling DCI or a multicast or broadcast scheduling DCI, based on at least one of: a radio network temporary identifier (RNTI) scrambling the DCI, a DCI format of the DCI, a DMRS of the DCI, or a pre-determined field of the DCI;
when the DCI is a unicast scheduling DCI, selecting a first configuration for the at least one feedback from CSI feedback configurations for unicast, based on an indication of a CSI feedback triggering field in the DCI; and
when the DCI is a multicast or broadcast scheduling DCI, selecting a second configuration for the at least one feedback from CSI feedback configurations for multicast or broadcast, based on an indication of a CSI feedback triggering field in the DCI,
wherein the CSI feedback configurations for unicast, multicast or broadcast are determined based on a semi-static configuration by the wireless communication node or based on a system pre-definition.

13. The method of claim 11, further comprising:
determining whether the DCI is a unicast scheduling DCI or a multicast or broadcast scheduling DCI, based on at least one of: a radio network temporary identifier (RNTI) scrambling the DCI, or a pre-determined field of the DCI;
when the DCI is a unicast scheduling DCI, determining a physical uplink control channel (PUCCH) resource for transmitting the at least one feedback, based on a first method; and
when the DCI is a multicast or broadcast scheduling DCI, determining a physical uplink control channel (PUCCH) resource for transmitting the at least one feedback, based on a second method different from the first method.

14. (canceled)

15. (canceled)

16. A method performed by a wireless communication node, the method comprising:
performing a downlink transmission on a downlink transmission channel to a wireless communication device; and
receiving, from the wireless communication device, at least one feedback related to channel state information (CSI), wherein the at least one feedback is generated based on at least one of: a channel state information reference signal (CSI-RS) resource, a channel state information interference measurement (CSI-IM) resource, or a transport block transmitted in the downlink transmission channel.

17. The method of claim 16, wherein:
the at least one feedback is generated based on a hybrid automatic repeat request acknowledgement (HARQ-ACK) message in response to the downlink transmission; and/or
the at least one feedback has a type that is selected from a plurality of types based on content of the HARQ-ACK message.

18. The method of claim 17, wherein:
the at least one feedback has a first type when the HARQ-ACK message has a first content; and
the at least one feedback has a second type when the HARQ-ACK message has a second content.

19. (canceled)

20. (canceled)

21. (canceled)

22. (canceled)

23. (canceled)

24. The method of claim 17, wherein the at least one feedback is generated based on:
selecting at least one CSI-RS occasion;
deriving a channel measurement for computing the at least one feedback based on the at least one CSI-RS occasion;
calculating a channel quality value based on the channel measurement; and
generating the at least one feedback based on the channel quality value, wherein the at least one CSI-RS occasion is selected based on at least one of the following:
all CSI-RS occasions no later than a reference resource of the at least one feedback;
CSI-RS occasions with channel peak values, among all CSI-RS occasions no later than the reference resource of the at least one feedback, wherein each channel peak value is a maximum value or a value larger than a threshold determined based on a semi-static configuration by the wireless communication node or based on a system pre-definition;
CSI-RS occasions with channel peak values, among all CSI-RS occasions no later than the reference resource of the at least one feedback, wherein each channel peak value is determined based on: an average channel value, and a threshold determined based on a semi-static configuration by the wireless communication node or based on a system pre-definition;
CSI-RS occasions with top N channel values, among all CSI-RS occasions no later than the reference resource of the at least one feedback, wherein N is a positive integer determined based on a semi-static configuration by the wireless communication node or based on a system pre-definition;
CSI-RS occasions with channel valley values, among all CSI-RS occasions no later than the reference resource of the at least one feedback, wherein each channel valley value is a minimum value or a value smaller than a threshold determined based on a semi-static configuration by the wireless communication node or based on a system pre-definition;
CSI-RS occasions with channel valley values, among all CSI-RS occasions no later than the reference resource of the at least one feedback, wherein each channel valley value is determined based on: an average channel value, and a threshold determined based on a semi-static configuration by the wireless communication node or based on a system pre-definition;
CSI-RS occasions with bottom M channel values, among all CSI-RS occasions no later than the reference resource of the at least one feedback, wherein M is a positive integer determined based on a semi-static configuration by the wireless communication node or based on a system pre-definition;
CSI-RS occasions without channel peak values, among all CSI-RS occasions no later than the reference resource of the at least one feedback;
CSI-RS occasions without channel valley values, among all CSI-RS occasions no later than the reference resource of the at least one feedback; or
latest L CSI-RS occasions among all CSI-RS occasions no later than the reference resource of the at least one feedback, wherein L is a positive integer determined based on a semi-static configuration by the wireless communication node or based on a system pre-definition.

25. The method of claim 17, wherein the at least one feedback is generated based on:
selecting at least one CSI-RS occasion or at least one CSI-IM occasion;
deriving an interference measurement for computing the at least one feedback based on the at least one CSI-RS occasion or the at least one CSI-IM occasion;
calculating an interference quality value based on the interference measurement; and
generating the at least one feedback based on the interference quality value, wherein the at least one CSI-RS occasion or the at least one CSI-IM occasion is selected based on at least one of the following:
all CSI-RS or CSI-IM occasions no later than a reference resource of the at least one feedback;
CSI-RS or CSI-IM occasions with interference peak values, among all CSI-RS or CSI-IM occasions no later than the reference resource of the at least one feedback, wherein each interference peak value is a maximum value or a value larger than a threshold determined based on a semi-static configuration by the wireless communication node or based on a system pre-definition;
CSI-RS or CSI-IM occasions with interference peak values, among all CSI-RS or CSI-IM occasions no later than the reference resource of the at least one feedback, wherein each interference peak value is determined based on: an average interference value, and a threshold determined based on a semi-static configuration by the wireless communication node or based on a system pre-definition;
CSI-RS or CSI-IM occasions with top X interference values, among all CSI-RS or CSI-IM occasions no later than the reference resource of the at least one feedback, wherein X is a positive integer determined based on a semi-static configuration by the wireless communication node or based on a system pre-definition;
CSI-RS or CSI-IM occasions with interference valley values, among all CSI-RS or CSI-IM occasions no later than the reference resource of the at least one feedback, wherein each interference valley value is a minimum value or a value smaller than a threshold determined based on a semi-static configuration by the wireless communication node or based on a system pre-definition;
CSI-RS or CSI-IM occasions with interference valley values, among all CSI-RS or CSI-IM occasions no later than the reference resource of the at least one feedback, wherein each interference valley value is determined based on: an average interference value, and a threshold determined based on a semi-static configuration by the wireless communication node or based on a system pre-definition;
CSI-RS or CSI-IM occasions with bottom Y interference values, among all CSI-RS or CSI-IM occasions no later than the reference resource of the at least one feedback, wherein Y is a positive integer determined based on a semi-static configuration by the wireless communication node or based on a system pre-definition;
CSI-RS or CSI-IM occasions without interference peak values, among all CSI-RS or CSI-IM occasions no later than the reference resource of the at least one feedback;
CSI-RS or CSI-IM occasions without interference valley values, among all CSI-RS or CSI-IM occasions no later than the reference resource of the at least one feedback; or
latest Z CSI-RS or CSI-IM occasions among all CSI-RS or CSI-IM occasions no later than the reference resource of the at least one feedback, wherein Z is a positive integer determined based on a semi-static configuration by the wireless communication node or based on a system pre-definition.

26. (canceled)

27. (canceled)

28. (canceled)

29. A method performed by a wireless communication node, the method comprising:
receiving, from a wireless communication device, a sounding reference signal (SRS) resource generated based on a scheduling type of downlink control information (DCI) triggering the SRS resource from the wireless communication node, wherein:
the DCI is determined by the wireless communication device to be a unicast scheduling DCI or a multicast or broadcast scheduling DCI;
when the DCI is determined to be a unicast scheduling DCI, a first SRS resource group is selected by the wireless communication device from SRS resource groups for antenna switching based on unicast, based on an indication of a SRS triggering field in the DCI;
when the DCI is determined to be a multicast or broadcast scheduling DCI, a second SRS resource group is selected by the wireless communication device from SRS resource groups for antenna switching based on multicast or broadcast, based on an indication of a SRS triggering field in the DCI; and
the SRS resource is received according to the selected SRS resource group.

30. The method of claim 29, wherein:
the DCI is determined to be a unicast scheduling DCI or a multicast or broadcast scheduling DCI, based on at least one of: a radio network temporary identifier (RNTI) scrambling the DCI, or a pre-determined field of the DCI; and
the SRS resource groups for antenna switching based on unicast, multicast or broadcast are determined based on a semi-static configuration by the wireless communication node or based on a system pre-definition.

31. (canceled)

32. (canceled)

33. (canceled)
